(19) United States
(12) Patent Application Publication
(10) Pub. No.: US 2026/0150167 A1
(43) Pub. Date: May 28, 2026

(54) LED DRIVER AND OPERATING METHOD THEREOF

(71) Applicant: Delta Electronics, Inc., Taoyuan City (TW)

(72) Inventors: Ching-Ho Chou, Taoyuan City (TW); Yung-Chuan Lu, Taoyuan City (TW); Ming-Lung Hsieh, Taoyuan City (TW); Chien-Ting Lin, Taoyuan City (TW)

(21) Appl. No.: 19/270,004

(22) Filed: Jul. 15, 2025

Related U.S. Application Data
(60) Provisional application No. 63/725,076, filed on Nov. 26, 2024.

(30) Foreign Application Priority Data
May 20, 2025 (CN) 202510649004.0

(51) Int. Cl. H05B 45/59; H05B 45/10; H05B 45/325; H05B 45/355; H05B 45/375; H05B 45/38

(52) U.S. Cl. CPC H05B 45/59; H05B 45/10; H05B 45/325; H05B 45/355; H05B 45/375; H05B 45/38

(57) ABSTRACT

An LED driver and an operating method thereof are provided. The LED driver includes a conversion circuit, a switch circuit and a control circuit. The positive and negative output terminals of the conversion circuit are electrically coupled to the LED light source through two switches of the switch circuit respectively. After the control circuit receives a light-off command, the control circuit generates the dimming signal to configure the conversion circuit to decrease the output current; and when the control circuit determines that the output current is less than a turn-off current threshold, the control circuit configures the two switches of the switch circuit to be in a non-conduction state.

### CROSS-REFERENCE TO RELATED APPLICATION

This application claims the benefit of U.S. Provisional Application No. 63/725,076 filed on Nov. 26, 2024 and titled “MULTI-CHANNEL LED DRIVER WITH RESIDUAL CURRENT DISCONNECT PROTECTION”. This application also claims priority to China Patent Application No. 202510649004.0 filed on May 20, 2025. The entire contents of the above-mentioned patent applications are incorporated herein by reference for all purposes.

### FIELD OF THE INVENTION

The present disclosure relates to an LED (light-emitting diode) driver and an operating method thereof, and more particularly to an LED driver and an operating method thereof capable of avoiding the occurrence of afterglow phenomenon.

### BACKGROUND OF THE INVENTION

In lighting applications, in order for an LED light source to operate stably and efficiently, an LED driver is usually used to provide appropriate voltage and current. When the LED driver adopts a dual live-wire input, the two input terminals of the LED driver are electrically coupled to two live wires of an AC power source respectively. In addition, since the LED light source and some components such as the lamp housing need to be grounded, a voltage difference exists between the output terminal of the LED driver and the ground terminal. Therefore, when the light is turned off, even a small amount of current flowing through the LED light source would cause the LED light source to emit faint light (hereinafter referred to as the afterglow phenomenon). Moreover, even if the LED driver adopts a single-phase AC input power source, the afterglow phenomenon still cannot be avoided.

Some LED drivers include a semiconductor component disposed at the positive output terminal and/or the negative output terminal to achieve a cut-off function. Although the semiconductor component has a long service life, the leakage current generated by the interface capacitance of the semiconductor causes the LED light source to exhibit the afterglow phenomenon. Some LED drivers may include mechanical switches disposed at the positive output terminal and the negative output terminal to eliminate the afterglow phenomenon. Although the mechanical switch has a large physical insulation distance and may reduce the afterglow phenomenon, the service life (i.e., the number of switching operations) of the mechanical switch is limited. Accordingly, this approach is not suitable for applications requiring a high number of switching operations, such as LED light sources installed in sports fields or exhibition halls where maintenance of LED light sources is difficult.

Therefore, there is a need of providing an LED driver and an operating method thereof in order to overcome the drawbacks of the conventional technologies.

### SUMMARY OF THE INVENTION

The present disclosure provides an LED driver and an operating method thereof in order to overcome the drawbacks of the conventional technologies.

In accordance with an aspect of the present disclosure, an LED driver is provided. The LED driver is configured to be electrically coupled to an AC power source for supplying power to a first LED light source, and includes a first conversion circuit, a first switch circuit and a control circuit. The first conversion circuit is configured to generate a first output voltage and a first output current for supplying power to the first LED light source. The first switch circuit includes two switches, and a positive output terminal and a negative output terminal of the first conversion circuit are electrically coupled to the first LED light source through the two switches respectively. The control circuit is electrically coupled to the first conversion circuit and the first switch circuit, and configured to receive a control command and generate a dimming signal to correspondingly configure the first conversion circuit to generate the first output voltage and the first output current. After the control circuit receives a light-off command, the control circuit generates the dimming signal to configure the first conversion circuit to decrease the first output current; and when the control circuit determines that the first output current flowing through the first switch circuit is less than a turn-off current threshold, the control circuit configures the two switches of the first switch circuit to be in a non-conduction state.

In accordance with another aspect of the present disclosure, an operating method of an LED driver is provided. The LED driver is configured to be electrically coupled to an AC power source for supplying power to a first LED light source. The LED driver includes a first conversion circuit, a first switch circuit and a control circuit, and a positive output terminal and a negative output terminal of the first conversion circuit are electrically coupled to the first LED light source through two switches of the first switch circuit respectively. The control circuit is electrically coupled to the first conversion circuit and the first switch circuit. The operating method includes: configuring the control circuit to receive a control command and generate a dimming signal to correspondingly configure the first conversion circuit to generate a first output voltage and a first output current for supplying power to the first LED light source; and after the control circuit receives a light-off command, generating the dimming signal to configure the first conversion circuit to decrease the first output current by the control circuit, and when the control circuit determines that the first output current flowing through the first switch circuit is less than a turn-off current threshold, configuring the two switches of the first switch circuit to be in a non-conduction state by the control circuit.

In the present disclosure, the switches are disposed at the positive output terminal and the negative output terminal of the conversion circuit so that the generation of residual current and the resulting afterglow phenomenon are avoided. Further, the switches are controlled to switch between conduction state and non-conduction state when the current is below the current threshold, thereby extending the service life of the switches.

### BRIEF DESCRIPTION OF THE DRAWINGS

FIG. 1 is a schematic block diagram illustrating an LED driver according to an embodiment of the present disclosure;

FIG. 2A is a schematic flow chart illustrating an operating method of the LED driver when turning on the LED light source according to an embodiment of the present disclosure;

FIG. 2B schematically shows a timing diagram corresponding to the operating method of FIG. 2A;

FIG. 3A is a schematic flow chart illustrating an operating method of the LED driver when turning off the LED light source according to an embodiment of the present disclosure;

FIG. 3B schematically shows a timing diagram corresponding to the operating method of FIG. 3A;

FIG. 4 is a schematic block diagram illustrating an LED driver according to another embodiment of the present disclosure; and

FIG. 5 is a schematic block diagram illustrating an LED driver according to another embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

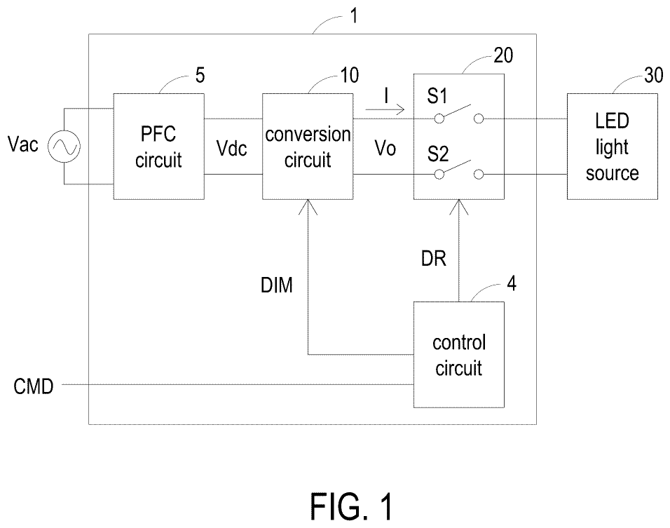

FIG. 1 is a schematic block diagram illustrating an LED driver according to an embodiment of the present disclosure. As shown in FIG. 1, the LED driver 1 is electrically coupled to an AC power source Vac (e.g., two live wires of a three-phase AC power source, or a single-phase AC power source) for supplying power to an LED light source 30. For example, the LED driver 1 is electrically coupled to two phases of a three-phase AC voltage (each providing an AC voltage of 277V with respect to the ground terminal) such that an input voltage between two input terminals of the LED driver 1 is an AC voltage of 480V. In the embodiment shown in FIG. 1, the LED driver 1 includes a PFC (power factor correction) circuit 5, a conversion circuit 10, a switch circuit 20, and a control circuit 4. The switch circuit 20 is electrically coupled between the conversion circuit 10 and the LED light source 30, and the control circuit 4 is electrically coupled to the conversion circuit 10 and the switch circuit 20. For the sake of brevity, other components of the LED driver 1 are not depicted in FIG. 1. In this embodiment, the LED driver 1 is divided into the PFC circuit 5, the conversion circuit 10, the switch circuit 20, and the control circuit 4 for clearly describing the operation of the LED driver 1. The PFC circuit 5, the conversion circuit 10, the switch circuit 20, and the control circuit 4 may be implemented by suitable components respectively, or may be integrated into or separately implemented by one or more components. In another embodiment, the functions of the PFC circuit 5, the conversion circuit 10, the switch circuit 20, and the control circuit 4 may be performed through collaborative operation of software, firmware and/or hardware, or maybe performed by adopting discrete components and/or integrated circuit components.

The PFC circuit 5 is electrically coupled to the AC power source Vac and is configured to generate a DC voltage Vdc according to the AC voltage provided by the AC power source Vac. The PFC circuit 5 may adopt a suitable power conversion architecture to implement power factor correction and provide the required DC voltage Vdc, for example but not limited to a passive PFC circuit, an active boost PFC circuit, or a bridgeless PFC circuit.

The conversion circuit 10 is electrically coupled to the PFC circuit 5 to receive the DC voltage Vdc, and is configured to generate an output voltage Vo according to the DC voltage Vdc to supply power to the LED light source 30. The conversion circuit 10 may adopt a suitable power conversion architecture to provide the power required by the LED light source 30, for example but not limited to a buck conversion circuit, an inverting buck conversion circuit, or a buck-boost conversion circuit.

The switch circuit 20 includes two switches S1 and S2. The switch S1 is electrically coupled between a positive output terminal of the conversion circuit 10 and the LED light source 30, and the switch S2 is electrically coupled between a negative output terminal of the conversion circuit 10 and the LED light source 30. In other words, the positive output terminal and the negative output terminal of the conversion circuit 10 are electrically coupled to the LED light source 30 through the two switches S1 and S2 respectively. The two switches S1 and S2 may adopt suitable switching elements. For instance, the switches S1 and S2 may adopt a double-pole single-throw relay, which provides function of synchronous conduction and non-conduction. In another embodiment, the switches S1 and S2 may respectively adopt one or more components such as relays, and the conduction state and non-conduction state of the switches S1 and S2 may be separately set.

The control circuit 4 is electrically coupled to the conversion circuit 10 and the switch circuit 20. The control circuit 4 may include components such as a microprocessor, a microcontroller and/or a logic circuit. The control circuit 4 may receive a control command CMD (e.g., a light-on command, a dimming command, and a light-off command) through a suitable wired and/or wireless control interface such as a digital addressable lighting interface (DALI), a universal asynchronous receiver/transmitter (UART), or a universal serial bus (USB), and correspondingly control the operation of components such as the conversion circuit 10 and the switch circuit 20 according to the control command CMD. For example, according to the received control command CMD, the control circuit 4 may correspondingly generate a dimming signal DIM to configure the conversion circuit 10 to generate a required output voltage Vo and/or output current I, and the control circuit 4 may also correspondingly generate a switch control signal DR to configure the two switches S1 and S2 of the switch circuit 20 to be in the conduction state or the non-conduction state.

Additionally, components of the LED driver 1 may be added or reduced according to different design considerations. For example, in the embodiment shown in FIG. 1, the LED driver 1 includes the PFC circuit 5. In another embodiment, the LED driver 1 is electrically coupled to a DC input power source and does not include the PFC circuit 5.

In this embodiment, the two switches S1 and S2 of the switch circuit 20 are electrically coupled to the positive output terminal and the negative output terminal of the conversion circuit 10 respectively. When it is required to turn off the LED light source 30, the control circuit 4 may control the switches S1 and S2 to be in the non-conduction state so that the positive and negative output terminals of the conversion circuit 10 are completely disconnected from the LED light source 30. Thereby, the residual current flowing into the LED light source 30, caused by the voltage difference between the positive or negative output terminal of the conversion circuit 10 and the ground terminal, is avoided, and thus the occurrence of the afterglow phenomenon is prevented. In an embodiment, the control circuit 4 detects the output current I flowing through the switch circuit 20. When the output current I is less than a current threshold, the control circuit 4 configures the two switches S1 and S2 of the switch circuit 20 to be in the conduction state or the non-conduction state. The current threshold may be set to a suitable value. For example, according to the rated current of the switches S1 and S2 and/or the rated current of the LED light source 30, the current threshold may be set to 20%, 10%, 5%, or 1% of the rated current of the LED light source 30. Accordingly, the switches S1 and S2 are switched under zero or low current condition, thereby extending the service life of the switches S1 and S2. When the output current I of the conversion circuit 10 is zero or is less than a turn-on current threshold, the control circuit 4 may configure the switches S1 and S2 to switch from the non-conduction state to the conduction state, thereby avoiding contact erosion and extending the service life of switches. When the output current I of the conversion circuit 10 is zero or is less than a turn-off current threshold, the control circuit 4 may configure the switches S1 and S2 to switch from the conduction state to the non-conduction state, thereby avoiding arcing during switching and also extending the service life of switches. In another embodiment, since the dimming signal DIM generated by the control circuit 4 can correspondingly configure the conversion circuit 10 to generate the output voltage Vo and/or the output current I, the control circuit 4 may estimate the output current I flowing through the switch circuit 20 according to the dimming signal DIM, without detecting the actual output current I flowing through the switch circuit 20. For example, when the control circuit 4 adopts the dimming signal DIM in a pulse width modulation (PWM) format, the control circuit 4 may estimate that the output current I flowing through the switch circuit 20 is less than the turn-off current threshold when the duty cycle of the dimming signal DIM is 0% or less than a duty cycle threshold (e.g., 10%, 5%, or 1%), and the control circuit 4 may then configure the switches S1 and S2 to switch from the conduction state to the non-conduction state. Thereby, the arcing during switching is avoided, and the service life of the switches is extended.

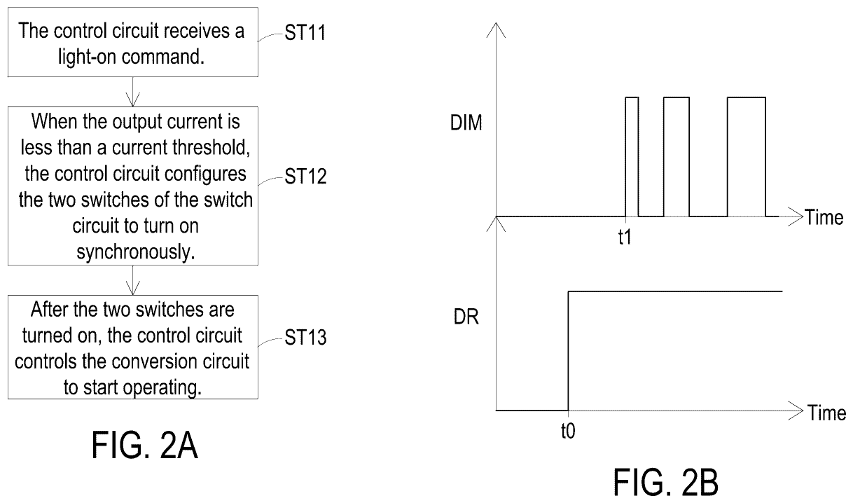

Please refer to FIG. 2A and FIG. 2B in conjunction with FIG. 1. FIG. 2A is a schematic flow chart illustrating an operating method of the LED driver when turning on the LED light source according to an embodiment of the present disclosure. FIG. 2B schematically shows a timing diagram corresponding to the operating method of FIG. 2A. This operating method is applicable to the LED driver 1 shown in FIG. 1. In FIG. 2B, when the control circuit 4 sets the switch control signal DR to a low level, the control circuit 4 correspondingly configures the switches S1 and S2 to be in the non-conduction state. When the control circuit 4 sets the switch control signal DR to a high level, the control circuit 4 correspondingly configures the switches S1 and S2 to be in the conduction state. The control circuit 4 configures the conversion circuit 10 to stop operating by setting the dimming signal DIM to a low level continuously, and the control circuit 4 configures the conversion circuit 10 to operate by intermittently setting the dimming signal DIM to a high level. For example, the control circuit 4 may configure the conversion circuit 10 to generate the required output voltage Vo and/or output current I by setting the turn-on frequency or duty cycle of the dimming signal DIM.

As shown in FIG. 2A and FIG. 2B, before time t0, the control circuit 4 sets both the dimming signal DIM and the switch control signal DR to a low level, thereby configuring the conversion circuit 10 to stop operating and configuring the switches S1 and S2 to be in the non-conduction state. After the control circuit 4 receives a light-on command (step ST11), at time t0, the control circuit 4 keeps the dimming signal DIM at a low level and generates the switch control signal DR at a high level to configure the two switches S1 and S2 of the switch circuit 20 to turn on (step ST12). After the switches S1 and S2 are turned on, at time t1, the control circuit 4 intermittently sets the dimming signal DIM to a high level to control the conversion circuit 10 to start operating (step ST13) such that the conversion circuit 10 correspondingly generates the output voltage Vo and the output current I to supply power to the LED light source 30. For example, when the control circuit 4 intermittently sets the dimming signal DIM to a high level, the control circuit 4 may gradually increase the duty cycle of the dimming signal DIM in PWM format so that the output voltage Vo and/or the output current I generated by the conversion circuit 10 gradually increase.

During the light-on process in this embodiment, as the control circuit 4 receives the light-on command, the control circuit 4 configures the switches S1 and S2 to turn on when the output current I of the conversion circuit 10 is less than a turn-on current threshold (e.g., when the output current I is 0).

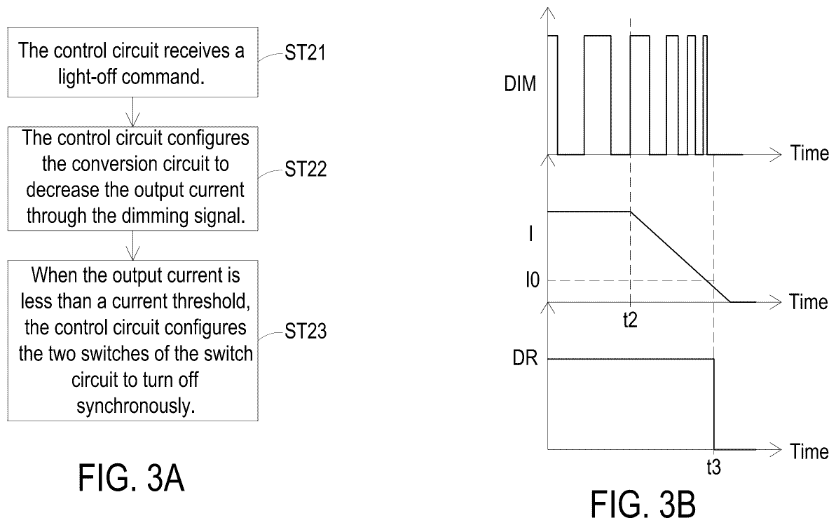

Please refer to FIG. 3A and FIG. 3B in conjunction with FIG. 1. FIG. 3A is a schematic flow chart illustrating an operating method of the LED driver when turning off the LED light source according to an embodiment of the present disclosure. FIG. 3B schematically shows a timing diagram corresponding to the operating method of FIG. 3A. This operating method is applicable to the LED driver 1 shown in FIG. 1. In this embodiment, the light-off command may be a control command that configures the LED driver 1 to dim the light until the LED light source 30 is turned off, or a control command that configures the LED driver 1 to stop supplying power to the LED light source 30 for turning off the LED light source 30. As shown in FIG. 3A and FIG. 3B, before time t2, the control circuit 4 sets the switch control signal DR to a high level so that the switches S1 and S2 are in the conduction state, and the control circuit 4 intermittently sets the dimming signal DIM to a high level to control the conversion circuit 10 to operate and supply power to the LED light source 30 through the switch circuit 20. Thus, the output current I flowing through the switch circuit 20 is high. After the control circuit 4 receives a light-off command (step ST21), at time t2, the control circuit 4 configures the conversion circuit 10 to decrease the output current I through the dimming signal DIM (step ST22). For example, the control circuit 4 may configure the conversion circuit 10 to decrease the output current I by decreasing the duty cycle of the dimming signal DIM in PWM format, decreasing the turn-on frequency of the dimming signal DIM in pulse frequency modulation format, or decreasing the DC level of the dimming signal DIM. As exemplified in FIG. 3B, during the period from time t2 to t3, the control circuit 4 gradually decreases the duty cycle of the dimming signal DIM (the duty cycle may be reduced to zero or to below a suitable duty cycle threshold) to correspondingly set the output current I generated by the conversion circuit 10 to gradually decrease. After the output current I flowing through the switch circuit 20 falls below a turn-off current threshold I0 (the control circuit 4 may detect the output current I or estimate the output current I based on the dimming signal DIM or the like), at time t3, the control circuit 4 sets the switch control signal DR to a low level to configure the two switches S1 and S2 of the switch circuit 20 to switch to the non-conduction state (step ST23). The turn-off current threshold I0 and the turn-on current threshold may be set to be the same or different.

Accordingly, during the light-off process, the control circuit 4 configures the switches S1 and S2 to switch to the non-conduction state when the output current I flowing through the switch circuit 20 is less than the turn-off current threshold I0. Therefore, the arcing caused by high output current I during the switching of the switches S1 and S2 can be avoided, thereby extending the service life of the switches S1 and S2.

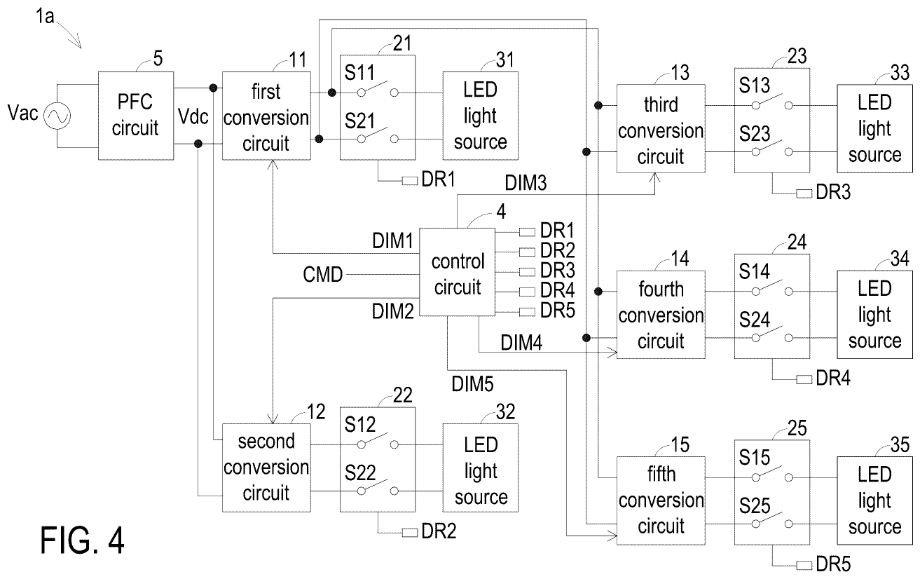

Please refer to FIG. 4. FIG. 4 is a schematic block diagram illustrating an LED driver according to another embodiment of the present disclosure. In FIG. 4, the component parts and elements corresponding to those of FIG. 1 are designated by identical numeral references, and detailed descriptions thereof are omitted herein. Compared to the LED driver 1 in the embodiment shown in FIG. 1, the LED driver 1a in the embodiment shown in FIG. 4 is configured to drive a plurality of LED light sources (five LED light sources 31, 32, 33, 34 and 35 are exemplified in the figure), and correspondingly includes a plurality of conversion circuits (five conversion circuits are exemplified in the figure, namely a first conversion circuit 11, a second conversion circuit 12, a third conversion circuit 13, a fourth conversion circuit 14, and a fifth conversion circuit 15) and a plurality of switch circuits (five switch circuits 21, 22, 23, 24 and 25 are exemplified in the figure). The first conversion circuit 11 and the second conversion circuit 12 form a first-stage circuit, and the third conversion circuit 13, the fourth conversion circuit 14, and the fifth conversion circuit 15 form a second-stage circuit. Each switch circuit is electrically coupled between the corresponding conversion circuit and the corresponding LED light source, and each switch circuit includes two switches which operate synchronously for conduction and switching. The control circuit 4 is electrically coupled to the plurality of conversion circuits and the plurality of switch circuits 21, 22, 23, 24 and 25 and controls their operation. For example, the control circuit 4 generates dimming signals DIM1, DIM2, DIM3, DIM4 and DIM5, and configures the first conversion circuit 11, the second conversion circuit 12, the third conversion circuit 13, the fourth conversion circuit 14, and the fifth conversion circuit 15 to generate corresponding output voltages and/or output currents according to the dimming signals DIM1, DIM2, DIM3, DIM4 and DIM5 respectively. The control circuit 4 further provides switch control signals DR1, DR2, DR3, DR4 and DR5. The switch control signal DR1 is configure to configure the two switches S11 and S21 of the switch circuit 21 to be in the conduction state or the non-conduction state. The switch control signal DR2 is configure to configure the two switches S12 and S22 of the switch circuit 22 to be in the conduction state or the non-conduction state. The switch control signal DR3 is configure to configure the two switches S13 and S23 of the switch circuit 23 to be in the conduction state or the non-conduction state. The switch control signal DR4 is configure to configure the two switches S14 and S24 of the switch circuit 24 to be in the conduction state or the non-conduction state. The switch control signal DR5 is configure to configure the two switches S15 and S25 of the switch circuit 25 to be in the conduction state or the non-conduction state. In addition, the first conversion circuit 11, the second conversion circuit 12, the third conversion circuit 13, the fourth conversion circuit 14, the and fifth conversion circuit 15 in this embodiment have structures, functions, and operating manners similar to those of the conversion circuit 10 in the above embodiments, and thus detailed descriptions thereof are omitted herein. The switch circuits 21, 22, 23, 24 and 25 in this embodiment have structures, functions, and operating manners similar to those of the switch circuit 20 in the above embodiments, and thus detailed descriptions thereof are omitted herein. The control circuit 4 may independently control each conversion circuit and switch circuit. For example, the control circuit 4 may independently control the output current and output voltage of each conversion circuit, and may independently control the switching state of the switches in each switch circuit.

In the first-stage circuit, the input terminals of the first conversion circuit 11 and the second conversion circuit 12 are electrically coupled in parallel and are both electrically coupled to the PFC circuit 5 to receive the DC voltage Vdc. Further, in the first-stage circuit, the positive and negative output terminals of each conversion circuit are electrically coupled to the corresponding LED light source for supplying power through the corresponding switch circuit. In the second-stage circuit, the input terminal of each conversion circuit is electrically coupled to the positive and negative output terminals of the corresponding conversion circuit in the first-stage circuit to receive power, and the positive and negative output terminals of each conversion circuit are electrically coupled to the corresponding LED light source for supplying power. The plurality of conversion circuits in the second-stage circuit may be electrically coupled to the same conversion circuit in the first-stage circuit, or may be electrically coupled to different conversion circuits in the first-stage circuit. In this embodiment, the input terminals of the third conversion circuit 13, the fourth conversion circuit 14, and the fifth conversion circuit 15 are all electrically coupled to the positive and negative output terminals of the first conversion circuit 11 to receive the output voltage of the first conversion circuit 11. Additionally, in an embodiment, the positive output terminals or the negative output terminals of all conversion circuits may be electrically coupled to each other.

In this embodiment, the DC voltage Vdc is greater than the output voltage of the first conversion circuit 11, and the output voltage of the first conversion circuit 11 is greater than the output voltages of the third conversion circuit 13, the fourth conversion circuit 14, and the fifth conversion circuit 15. The first conversion circuit 11 in the first-stage circuit steps down the DC voltage Vdc to a lower output voltage and then provides the output voltage to the third conversion circuit 13, the fourth conversion circuit 14, and the fifth conversion circuit 15 in the second-stage circuit. The third conversion circuit 13, the fourth conversion circuit 14, and the fifth conversion circuit 15 in the second-stage circuit convert the output voltage of the first conversion circuit 11 into lower output voltages respectively. The output voltages of the third conversion circuit 13, the fourth conversion circuit 14, and the fifth conversion circuit 15 may be configured as the same voltage value or different voltage values. In this embodiment, through a multi-stage step-down conversion operation, the conversion circuits in both the first-stage circuit and the second-stage circuits are allowed to operate in ranges with higher conversion efficiency. In another embodiment, it may be configured that the first conversion circuit 11 and the second conversion circuit 12 in the first-stage circuit respectively provide the output voltages to the third conversion circuit 13, the fourth conversion circuit 14, and the fifth conversion circuit 15 in the second-stage circuit, and the third conversion circuit 13, the fourth conversion circuit 14, and the fifth conversion circuit 15 convert the output voltages of the first conversion circuit 11 and the second conversion circuit 12 into lower output voltages.

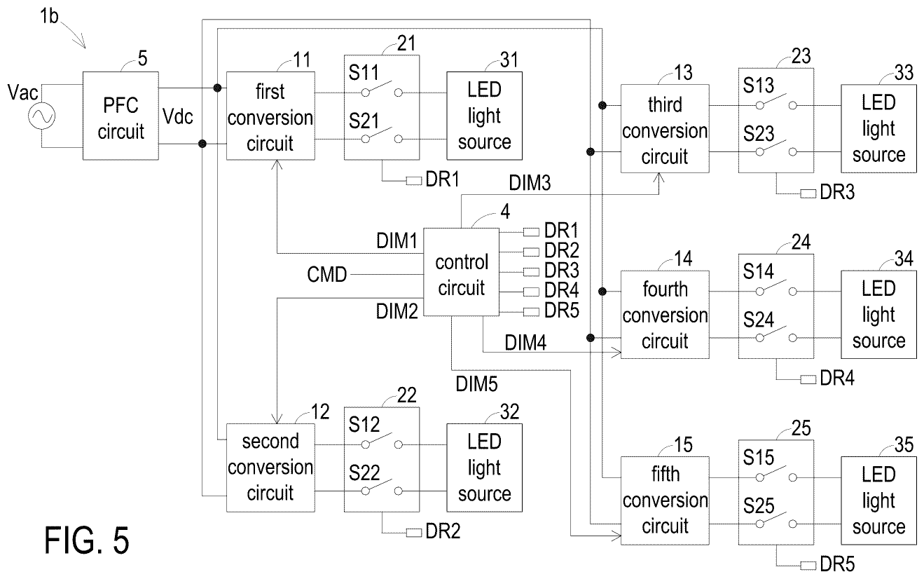

Additionally, in the embodiment shown in FIG. 4, the plurality of conversion circuits of the LED driver 1a form the circuit with two stages. In another embodiment, the plurality of conversion circuits of the LED driver may form the circuit with more stages, in which, except for the conversion circuits in the first-stage circuit, the input terminal of the conversion circuit in any stage is electrically coupled to the output terminal of the corresponding conversion circuit in the preceding stage. In addition, in further another embodiment, the plurality of conversion circuits of the LED driver may form a single-stage circuit, which means that the input terminals of all the conversion circuits are electrically coupled in parallel to each other and receive the same input voltage. Please refer to FIG. 5. FIG. 5 is a schematic block diagram illustrating an LED driver 1b according to another embodiment of the present disclosure. The major difference between the embodiments shown in FIG. 5 and FIG. 4 is that the conversion circuits (11-15) in FIG. 5 are all electrically coupled to the PFC circuit 5 and respectively convert the DC voltage Vdc into suitable output voltages for supplying power to the LED light sources 31-35.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An LED driver, configured to be electrically coupled to an AC power source for supplying power to a first LED light source, and comprising:
a first conversion circuit, configured to generate a first output voltage and a first output current for supplying power to the first LED light source;
a first switch circuit, comprising two switches, wherein a positive output terminal and a negative output terminal of the first conversion circuit are electrically coupled to the first LED light source through the two switches respectively; and
a control circuit, electrically coupled to the first conversion circuit and the first switch circuit, configured to receive a control command and generate a dimming signal to correspondingly configure the first conversion circuit to generate the first output voltage and the first output current;
wherein after the control circuit receives a light-off command, the control circuit generates the dimming signal to configure the first conversion circuit to decrease the first output current; and when the control circuit determines that the first output current flowing through the first switch circuit is less than a turn-off current threshold, the control circuit configures the two switches of the first switch circuit to be in a non-conduction state.

2. The LED driver according to claim 1, wherein after the control circuit receives a light-on command and determines that the first output current is less than a turn-on current threshold, the control circuit configures the two switches of the first switch circuit to be in a conduction state; and after the two switches are in the conduction state, the control circuit generates the dimming signal to configure the first conversion circuit to generate the first output voltage.

3. The LED driver according to claim 2, wherein the control circuit estimates the first output current according to the dimming signal to determine whether the first output current is less than the turn-on current threshold or the turn-off current threshold.

4. The LED driver according to claim 2, wherein the control circuit detects the first output current flowing through the first switch circuit to determine whether the first output current is less than the turn-on current threshold or the turn-off current threshold.

5. The LED driver according to claim 1, wherein the two switches of the first switch circuit comprise a double-pole single-throw relay.

6. The LED driver according to claim 1, further comprising a PFC circuit electrically coupled to the first conversion circuit and configured to be electrically coupled to the AC power source, wherein the PFC circuit is configured to generate a DC voltage according to two live wires of the AC power source, and the first conversion circuit is configured to generate the first output voltage according to the DC voltage.

7. The LED driver according to claim 1, further comprising a second conversion circuit and a second switch circuit, wherein the second conversion circuit is configured to generate a second output voltage and a second output current for supplying power to a second LED light source; the second switch circuit comprises two switches, and a positive output terminal and a negative output terminal of the second conversion circuit are electrically coupled to the second LED light source through the two switches of the second switch circuit respectively; the control circuit is electrically coupled to the second conversion circuit and the second switch circuit; and when the control circuit receives the light-off command and determines that the second output current of the second conversion circuit is less than the turn-off current threshold, the control circuit configures the two switches of the second switch circuit to be in the non-conduction state.

8. The LED driver according to claim 7, wherein when the control circuit receives a light-on command and determines that the second output current of the second conversion circuit is less than a turn-on current threshold, the control circuit configures the two switches of the second switch circuit to switch from the non-conduction state to a conduction state.

9. The LED driver according to claim 7, wherein two input terminals of the second conversion circuit are electrically coupled to the positive output terminal and the negative output terminal of the first conversion circuit respectively for generating the second output voltage according to the first output voltage.

10. The LED driver according to claim 7, further comprising a PFC circuit electrically coupled to the first conversion circuit and configured to be electrically coupled to the AC power source, wherein the PFC circuit is configured to generate a DC voltage according to two live wires of the AC power source; an input terminal of the first conversion circuit and an input terminal of the second conversion circuit are configured to be coupled to the PFC circuit; and the first conversion circuit and the second conversion circuit are configured to respectively generate the first output voltage and the second output voltage according to the DC voltage.

11. An operating method of an LED driver, wherein the LED driver is configured to be electrically coupled to an AC power source for supplying power to a first LED light source, the LED driver comprises a first conversion circuit, a first switch circuit and a control circuit, a positive output terminal and a negative output terminal of the first conversion circuit are electrically coupled to the first LED light source through two switches of the first switch circuit respectively, the control circuit is electrically coupled to the first conversion circuit and the first switch circuit, and the operating method comprises:
configuring the control circuit to receive a control command and generate a dimming signal to correspondingly configure the first conversion circuit to generate a first output voltage and a first output current for supplying power to the first LED light source; and
after the control circuit receives a light-off command, generating the dimming signal to configure the first conversion circuit to decrease the first output current by the control circuit, and when the control circuit determines that the first output current flowing through the first switch circuit is less than a turn-off current threshold, configuring the two switches of the first switch circuit to be in a non-conduction state by the control circuit.

12. The operating method according to claim 11, further comprising:
after the control circuit receives a light-on command and determines that the first output current is less than a turn-on current threshold, configuring the two switches of the first switch circuit to be in a conduction state by the control circuit, and after the two switches are in the conduction state, generating the dimming signal to configure the first conversion circuit to generate the first output voltage by the control circuit.

13. The operating method according to claim 12, further comprising:
estimating the first output current according to the dimming signal to determine whether the first output current is less than the turn-on current threshold or the turn-off current threshold by the control circuit.

14. The operating method according to claim 12, further comprising:
detecting the first output current flowing through the first switch circuit to determine whether the first output current is less than the turn-on current threshold or the turn-off current threshold by the control circuit.

15. The operating method according to claim 11, wherein the two switches of the first switch circuit comprise a double-pole single-throw relay.

16. The operating method according to claim 11, wherein the LED driver further comprises a PFC circuit electrically coupled to the first conversion circuit and configured to be electrically coupled to the AC power source, and the operating method further comprises: configuring the PFC circuit to generate a DC voltage according to two live wires of the AC power source, and configuring the first conversion circuit to generate the first output voltage according to the DC voltage.

17. The operating method according to claim 11, wherein the LED driver further comprises a second conversion circuit and a second switch circuit, the second conversion circuit is configured to generate a second output voltage and a second output current for supplying power to a second LED light source; the second switch circuit comprises two switches, and a positive output terminal and a negative output terminal of the second conversion circuit are electrically coupled to the second LED light source through the two switches of the second switch circuit respectively; the control circuit is electrically coupled to the second conversion circuit and the second switch circuit; and operating method further comprises:
when the control circuit receives the light-off command and determines that the second output current of the second conversion circuit is less than the turn-off current threshold, configuring the two switches of the second switch circuit to be in the non-conduction state by the control circuit.

18. The operating method according to claim 17, further comprising:
when the control circuit receives a light-on command and determines that the second output current of the second conversion circuit is less than a turn-on current threshold, configuring the two switches of the second switch circuit to switch from the non-conduction state to a conduction state by the control circuit.

19. The operating method according to claim 17, wherein two input terminals of the second conversion circuit are electrically coupled to the positive output terminal and the negative output terminal of the first conversion circuit respectively for generating the second output voltage according to the first output voltage.

20. The operating method according to claim 17, wherein the LED driver further comprises a PFC circuit electrically coupled to the first conversion circuit and configured to be electrically coupled to the AC power source, an input terminal of the first conversion circuit and an input terminal of the second conversion circuit are configured to be coupled to the PFC circuit, and the operating method further comprises:
configuring the PFC circuit to generate a DC voltage according to two live wires of the AC power source; and
configuring the first conversion circuit and the second conversion circuit to respectively generate the first output voltage and the second output voltage according to the DC voltage.
